(19) United States
(12) Patent Application Publication
(10) Pub. No.: US 2024/0002134 A1
(43) Pub. Date: Jan. 4, 2024

(54) Electrical Wire Compression Connector Dispensing Container

(71) Applicant: Leonard J. Dufrene, Des Allemands, LA (US)

(72) Inventor: Leonard J. Dufrene, Des Allemands, LA (US)

(21) Appl. No.: 18/369,787

(22) Filed: Sep. 18, 2023

(51) Int. Cl. B65D 83/00; B65D 25/00; B65D 25/22

(52) U.S. Cl. CPC B65D 83/0038; B65D 2203/02; B65D 25/22; B65D 25/005

(57) ABSTRACT

An electrical wire compression connector dispensing container device for individually dispensing single compression connectors comprises a housing defining a connector dispenser opening and a torsional spring operatively connected to a spring biased vertically movable horizontal platform for holding the compression connectors, allowing the platform to move upwards when the top compression connector is removed. The container can store a plurality of connectors with the top connector positioned in a dispenser opening. A bottom of the container has a weep hole for drainage of rainwater, and a back of the container has clamps providing a removable connection to a man-lift basket. A user can efficiently store and dispense a compression connector from the opening, and the torsional spring expands upwardly thereby pushing the next compression connector to a top row to be dispensed.

### BACKGROUND OF THE INVENTION

### Field of the Invention

The present invention relates generally to compression connectors storage devices and more particularly to a compression connectors storage and dispenser device.

### Description of the Related Art

Compression connectors are mechanical devices used to connect or terminate electrical wires. These connectors are widely used in the electrical industry due to their reliable and secure connections. They work by compressing the metal sleeve of the connector onto the wires being joined, creating a tight and strong bond between them.

However, compression connectors can be difficult to transport and store, especially for field technicians who need to carry them around for installation and repairs. Traditionally, these connectors are stored in bulk in bags or boxes, which can be cumbersome and inconvenient. Field technicians often have to carry around large, heavy containers of connectors, which can be difficult to manage and access while working on a job site.

When compression connectors are stored in bulk in bags or boxes, accessing them can be a hassle for field technicians who need to carry them around for installation and repairs. Each time a technician needs a connector, they have to open the bag or box, locate the connector they need, and then reseal the bag or box. This process can be time-consuming and can also expose the connectors to moisture, dirt, and other contaminants that can affect their performance.

In many scenarios, compression connectors are stored with other items in bags by operators which damages the connectors. When placed in pockets, an operator is required to sift through items to find a compression connector.

None of the existing devices for storing compression connectors provide a convenient, effective, and efficient way to store and access the compression connectors.

A need also exists for a new type of compression connector storage system that allows for the compression connectors to be organized and stored in a more efficient and convenient way, preventing them from getting lost or damaged during transport while allowing operators to easily dispense them from the storage system.

While conventional storage devices may be suitable for storing bulk compression connectors, they would not be as suitable for the purposes of the present invention as disclosed hereafter. None of such conventional devices disclose the unique structures and advantages of the present disclosure. The devices disclosed herein avoid many of the drawbacks of existing devices.

Accordingly, there is a need for an improved compression connector storage system that improves the storage and access process of the compression connectors.

It is one prospect of the present invention to provide a novel electrical wire compression connector dispensing container that dispenses connectors for easy access to operators.

Another object of the present invention is to provide an electrical wire compression connector dispensing container that keeps the connectors organized and easily accessible, allowing a technician to quickly access a connector.

Yet another object of the disclosed invention is to provide a compression connector dispensing container that can be easily transported to different job sites.

Yet another object of the disclosed invention is to provide a compression connector dispensing container that helps to reduce waste by minimizing the chance of connectors being lost or damaged during storage or transport.

As disclosed in this application, the inventor has discovered a novel and unique compression connector dispensing container for efficiently and effectively storing and accessing compression connectors.

Embodiments of the present invention provide for a compression connector dispensing container as described and defined in the description below and in the annexed claims which provide for improved safety, efficiency and effectiveness characteristics in order to conveniently and more effectively transport and access compression connectors in a multitude of environments.

### SUMMARY OF THE INVENTION

The following presents a simplified summary of the present disclosure in a simplified form as a prelude to the more detailed description that is presented herein.

Therefore, in accordance with embodiments of the invention, there is provided an electrical wire compression connector dispensing container. The electrical wire compression connector dispensing container comprises a generally square or rectangular housing having a front wall, a bottom surface, a pair of side walls, a rear wall and a top surface. A connector dispenser opening is formed between the top surface and the top edge of the front wall. The connector dispenser opening has a pair of side offset walls. A torsional spring has a bottom end which is connected to the inner surface of the bottom surface and has a top end which is connected to bottom surface of a spring biased vertically movable horizontal platform. A plurality of electrical wire connectors is stacked on the top surface of the spring biased vertically movable horizontal platform. When the topmost connector from the stack of connectors is dispensed from the connector dispenser opening, the torsional spring extends to move the spring biased vertically movable horizontal platform towards the top surface to allow a user to access the subsequent compression connector.

Preferably, a connector positioned just below the dispensed connector is placed in the connector dispenser opening when the torsional spring extends to move the spring biased vertically movable horizontal platform towards the top surface.

In a preferred embodiment, length of the vertical edge of the first offset side wall portion and length of the vertical portion of the second offset side wall portion are substantially equal and at least equal to height of a conventional connector.

In a preferred embodiment, the rear wall has one or more clamps integrated or detachably attached thereto, wherein the clamps are used for removably connecting the dispensing container to a frame of a man-lift basket.

In one embodiment, the bottom surface has at least one weep hole disposed therein and is adapted for a drainage of liquid.

In another embodiment, an indicium is disposed on the front wall, wherein the indicium indicates the size of the compression connector stored in the container.

In another embodiment, the electrical wire compression connector dispensing container is made of aluminum, metal, plastic, or rubber.

These and other features, aspects, and advantages of the present invention will become better understood with reference to the following description and appended claims.

### BRIEF DESCRIPTION OF THE DRAWINGS

Illustrative embodiments of the present invention are described herein with reference to the accompanying drawings, in which:

FIG. 1 illustrates the electrical wire compression connector dispensing container, in accordance with embodiments of the invention;

FIG. 2 illustrates a side perspective view of the electrical wire compression connector dispensing container, showing the offset wall of the dispensing opening, in accordance with embodiments of the invention;

FIG. 3 illustrates the electrical wire compression connector dispensing container with the front wall removed and showing a plurality of connectors placed on the spring biased vertically movable horizontal platform, in accordance with embodiments of the invention;

FIG. 4 illustrates the electrical wire compression connector dispensing container with the torsional spring in a fully extended position, in accordance with embodiments of the invention;

FIG. 5 illustrates a close-up view showing a user dispensing a connector from the dispensing opening of the electrical wire compression connector dispensing container, in accordance with embodiments of the invention;

FIG. 6 is a bottom perspective view of the electrical wire compression connector dispensing container, showing the weep hole in the bottom surface, in accordance with embodiments of the invention;

FIG. 7 is a rear perspective view of the electrical wire compression connector dispensing container, showing the clamp attached to the rear wall, in accordance with embodiments of the invention;

FIG. 8 illustrates the electrical wire compression connector dispensing container removably connected to frame of a man-lift basket, in accordance with embodiments of the invention;

FIG. 9 illustrates an exploded view of the electrical wire compression connector dispensing container, in accordance with embodiments of the invention;

FIG. 10 illustrates a row of electrical wire compression connector dispensing containers of different sizes, in accordance with embodiments of the invention;

FIG. 11 illustrates different size containers hanging in a work bucket, in accordance with embodiments of the invention;

FIG. 12 illustrates a close view of the container hanging in the work bucket, in accordance with embodiments of the invention; and

FIG. 13 illustrates a perspective view of the container placed in a basket in a work bucket, in accordance with embodiments of the invention.

### DETAILED DESCRIPTION

For a further understanding of the nature and function of the embodiments, reference should be made to the following detailed description. Detailed descriptions of the embodiments are provided herein, as well as the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure. Reference will now be made in detail to the present preferred embodiments of the invention, examples of which are illustrated in the accompanying drawings. Wherever possible, the same reference numerals are used in the drawings and the description to refer to the same or like parts.

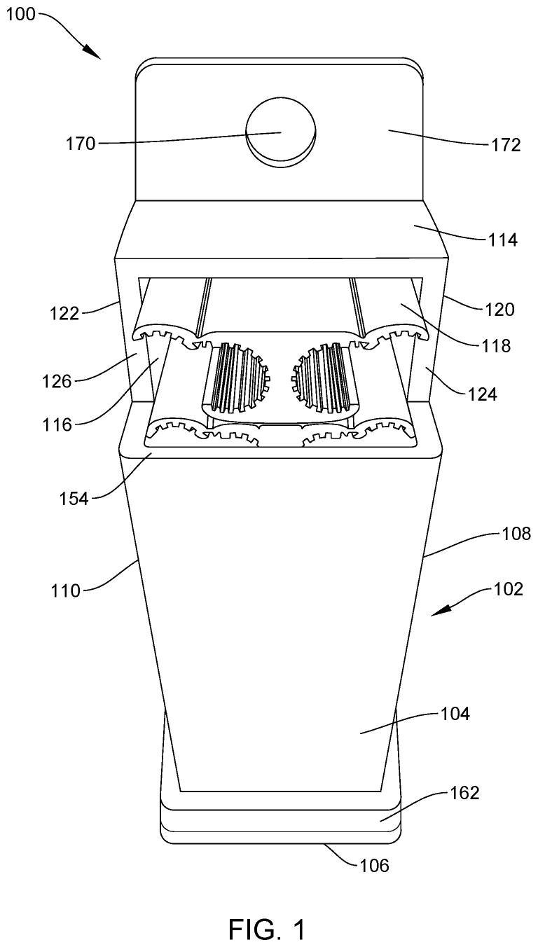

Referring initially to FIGS. 1-7 and 9, the basic constructional details and principles of operation of embodiments of an electrical wire compression connector dispensing container 100 are provided.

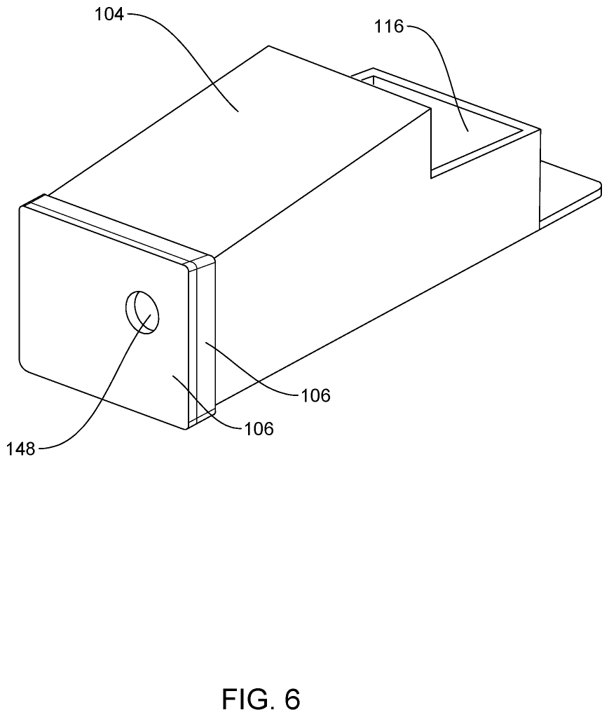

As illustrated in FIG. 1, in a preferred embodiment, the disclosed electrical wire compression connector dispensing container 100 includes a generally square or rectangular housing 102 having a front wall 104, a bottom surface 106 as illustrated in FIG. 6, a pair of side walls 108,110, a rear wall 112 and a top surface 114. The dispensing container 100 has a connector dispenser opening 116 disposed between the top surface 114 and the top edge 154 of the front wall 104. The connector dispenser opening 116 is adapted to dispense a single compression connector 118 therefrom allowing an operator to easily access the connector 118. A supporting member or portion in the form of a tab 172, which defines an opening 170 therethrough, extends vertically from the top surface 114 of the housing 102, as illustrated in FIGS. 1-5 and FIGS. 7-10. In the art, compression connectors 118 are also known as “squeez-ons.”

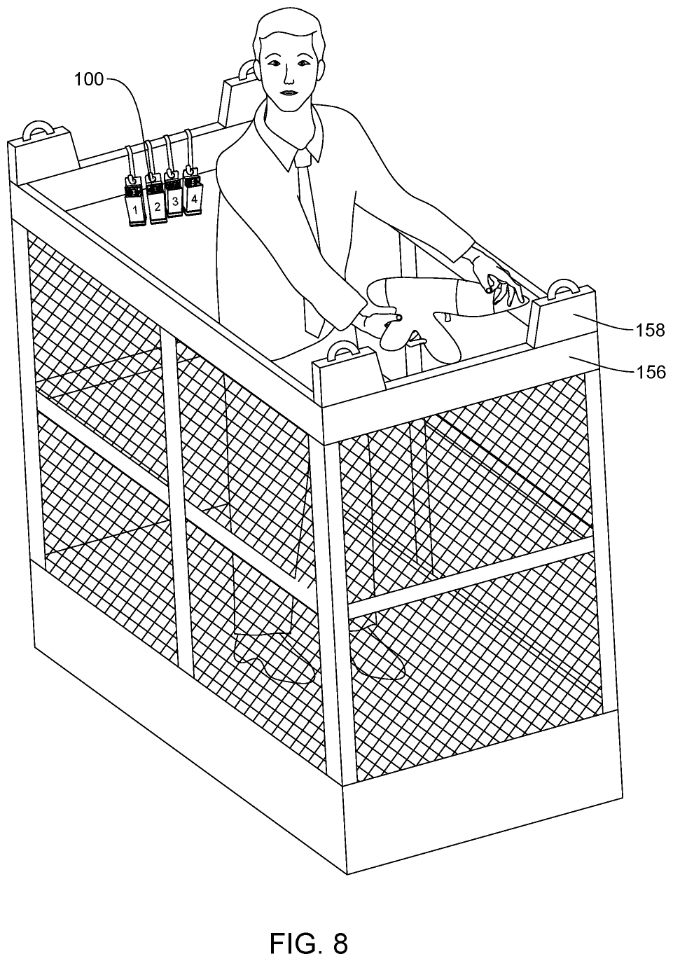

The supporting member 172 is used to facilitate hanging the container 100 on a hook connected to a frame 156 of a man-lift basket 158, as illustrated in FIG. 8 and FIGS. 11-12 for easy storage and accessibility. The supporting member or tab 172 is generally rectangular or square and also functions as an extension of the rear wall 112.

An indicium 166 indicating a size of the compression connectors 128 stored inside the container 100 is positioned on the front wall 104 of the housing 128. The indicium 166 can represent the industry standard size of the compression connectors 128 used by operators.

Referring to FIGS. 1-2 and 4-5, the opening 116 also has a first offset side wall portion 120 and a second offset side wall portion 122. In the preferred embodiment, the length of the vertical edge 124 of the first offset side wall portion 120 and length of the vertical edge 126 of the second offset side wall portion 122 is at least equal to height of the conventional connector 118, thereby allowing the connector 118 to be easily accessible for dispensing from the connector dispenser opening 116.

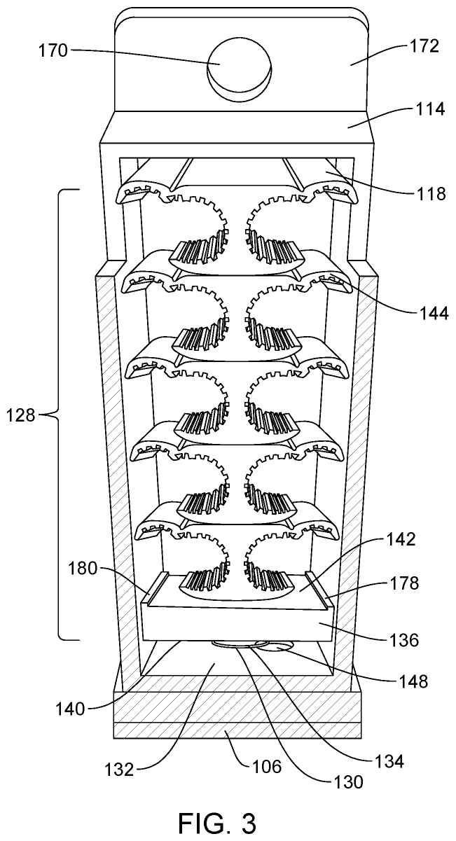

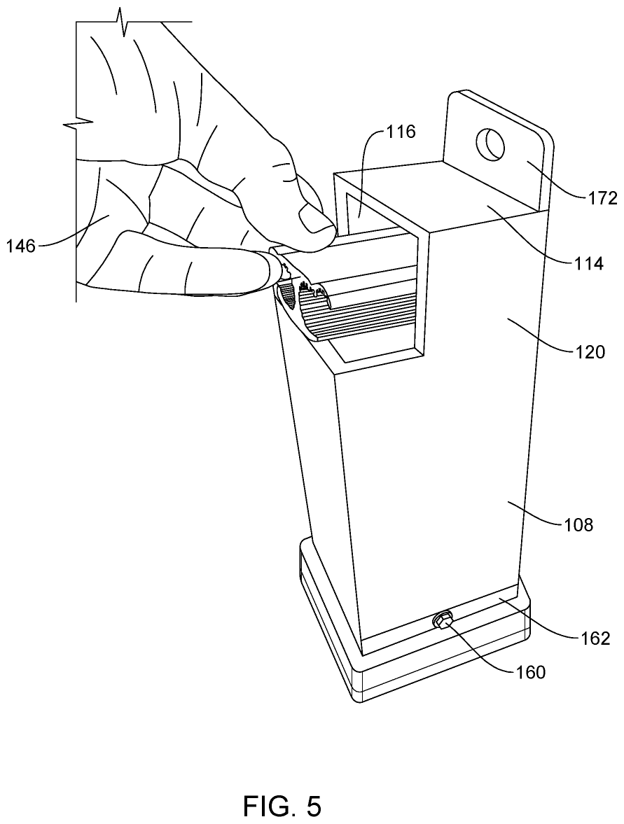

Referring to FIGS. 1 and 3, the housing 102 stores a plurality of identical connectors 128 (with the top connector referred to by the numeral 118). The connectors 128 are positioned on top of each other, with the top connector 118 positioned in the connector dispenser opening 116, enabling a user to access and dispense the top connector 118 as illustrated in FIG. 5. In one embodiment, the width of the front wall 104 is slightly longer than the width of the individual connectors 128, thereby enabling easy storage of the connectors 128.

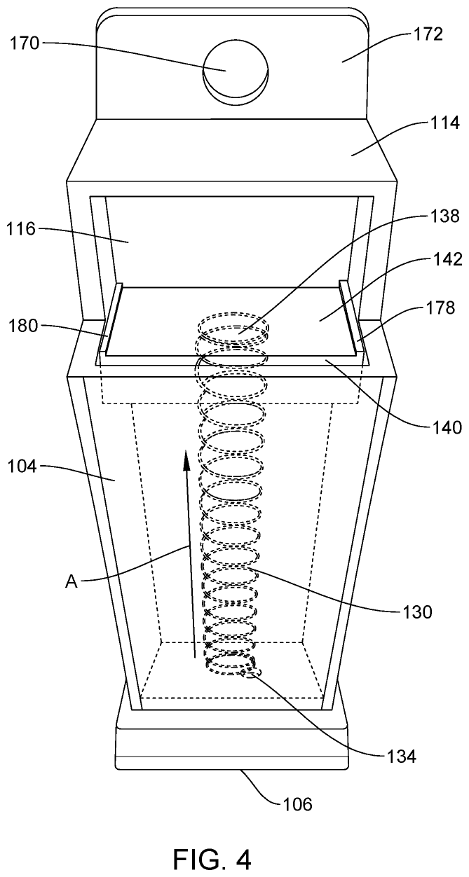

Referring again to FIGS. 3-4, the dispensing container 100 has a torsional spring 130 with the bottom end 134 of the torsional spring 130 is connected to inner surface 132 of the bottom wall 106. A spring biased vertically movable horizontal platform 136 is connected to the opposite end 138 of the torsional spring 130 with the opposite end 138 integrally or removably attached to the bottom surface 140 of the spring biased vertically movable horizontal platform 136. The connectors 128 are placed on the top surface 142 of the spring biased vertically movable horizontal platform 136 such that the platform 136 moves vertically upwards (Arrow A, FIG. 4) towards the top surface 114 when the top connector 118 is taken out by a user as illustrated in FIG. 5. The torsional spring 130 extends to allow a connector 144 positioned just below the top connector 118 to be placed in the opening 116. The torsional spring 130 remains in a compressed position as illustrated in FIG. 3 when one or more connectors 128 are placed on the spring biased vertically movable horizontal platform 136. As the top positioned connector 118 is removed from the container device 100 through the opening 116, the torsional spring 130 extends, lifting upwardly towards the top surface 114.

The spring biased vertically movable horizontal platform 136 is generally rectangular and solid. Further, the side edges 178,180 of the platform 136 extend above the top surface 142, preventing a compression connector 118 that is placed on the platform 136 from sliding or tipping sideways. A second indicium 182 is positioned on the top surface 142, for alerting a user about the size of the compression connector 118, 128 intended to be used to secure an electrical connection between wires. The indicium 166 and the second indicium 182 also communicate to the user which size of compression connectors 128 are compatible with the respective platform 136. In a preferred embodiment, the indicium 166 and the second indicium 182 are either the same in value and representation, or different in value and representation, indicating the respective the size of compression connectors 128 stored in the container 100.

As illustrated in FIG. 4, the spring biased vertically movable horizontal platform 136 aligns with the top edge 154 of the front wall 104 in the opening 116 when no connector 128 is positioned on the spring biased vertically movable horizontal platform 136. In such orientation, the torsional spring 130 is in a fully extended position with the bottom end 134 of the torsional spring 130 remains connected to inner surface 132 of the bottom wall 106. This allows a user to easily put a plurality of connectors 128 on the spring biased vertically movable horizontal platform 136 for dispensing as per requirements of the users.

As illustrated in FIG. 5, when dispensing a connector 128 from the opening 116 and extending the torsional spring 130, a user using a hand 146 to grasp the top connector 118 and pull the tope connector 118 from the opening 116 with very little effort. Upon a dispensing of the top connector 118, the torsional spring 130 extends upwardly, and the subsequently below compression connector 144 that is positioned just below the top connector 118 (as illustrated in FIG. 4) is pushed vertically upwards by an expansion of the spring biased vertically movable horizontal platform 136, providing access to the next compression connector 144 to the user. Accordingly, the next compression connector 144 can be dispensed from the container device 100 in the next turn, at the desire of the user, as the next compression connector 118 is desired to be dispensed.

Referring now to FIG. 6, the bottom surface 106 has at least one weep hole 148 disposed therein. The weep hole 148 is adapted for a drainage of liquid such as water in case the dispensing container 100 gets rained on while used outdoors. A diameter of the weep hole 148 is preferably 0.25 inches; however, the diameter of the weep hole 148 can be based on size of the bottom surface 106 in different embodiments of the container device 100.

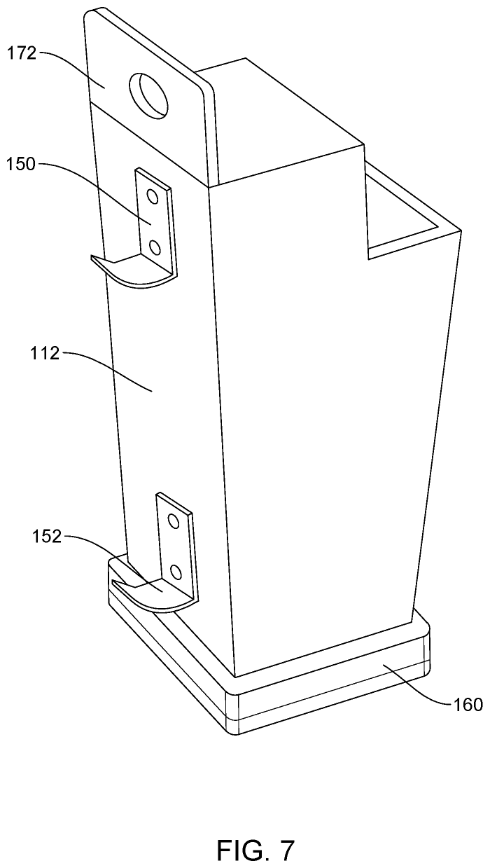

Now, referring to FIGS. 7-8, in one embodiment of the connector dispenser container 100, the rear wall 112 has one or more clamps 150,152 integrated or detachably attached thereto. The clamps 150,152 can be of any conventional shape and can be made of any durable and sturdy material. The clamps 150,152 are used to removably connect the dispensing container 100 to a frame 156 of a man-lift basket 158, thereby allowing easy access to the top compression connector of the plurality of compression connectors 128 that are stored in the dispensing container 100. More specifically, each clamp 150,152 connects to a grid of the frame 156 of the man-lift basket 158 thereby providing a secure connection of the dispensing container 100.

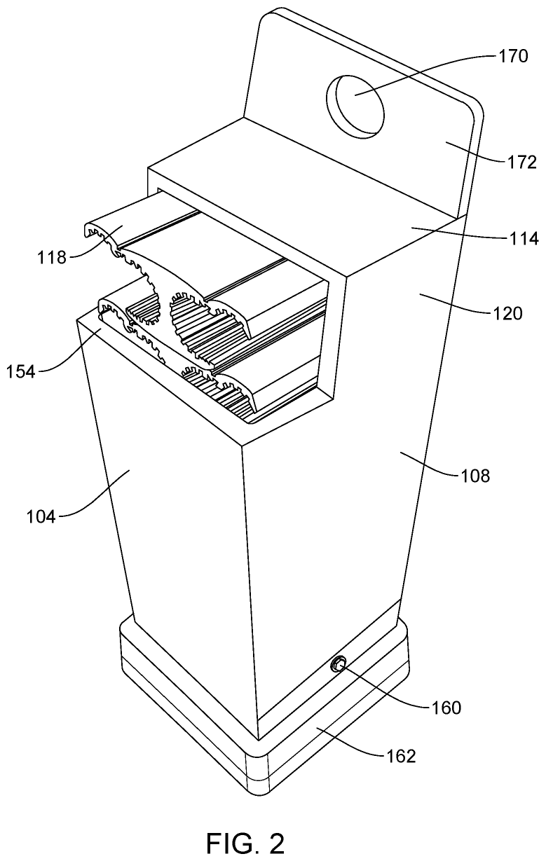

Referring again to FIGS. 2 and 5, in a preferred embodiment, the bottom surface 106 of the electrical wire compression connector dispensing container 100 is removable for replacing the spring 130 and/or the spring biased vertically movable horizontal platform 136. The bottom surface 106 can be removed by unfastening a mechanical fastener 160. The mechanical fastener 160 can be any fastener such as a screw.

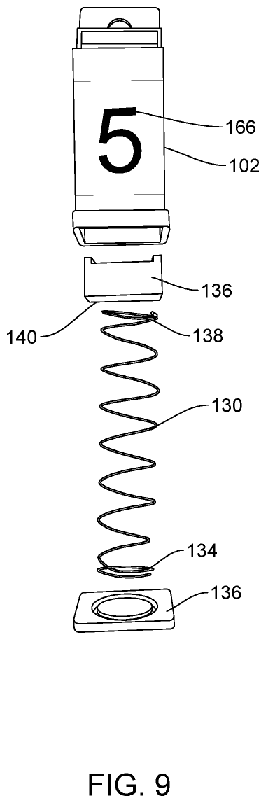

Referring now to FIG. 9, an exploded view of the electrical wire compression connector dispensing container 100 is shown. The bottom surface 106 of the electrical wire compression connector dispensing container 100 can be detachably attached or alternatively integrated to the base 162 of the housing 102 using welding or any conventional molding technique. The base 162 of the electrical wire compression connector dispensing container 100 can be made heavy for providing a stable position on any surface eliminating any tipping of the container 100 during use of the container 100 for retrieving the compression connectors. The torsional spring 130 is preferably attached to the bottom surface 106 of the housing 102 using the bottom end 134 of the spring 130, using adhesive or any mechanical fastener. The top end 138 of the spring 130 is attached to the bottom surface 140 of the platform 136. The spring biased platform 136 and the spring 130 are disposed inside the housing 102, with the bottom surface 106 of the electrical wire compression connector dispensing container 100 providing a sealed enclosure to the housing 102.

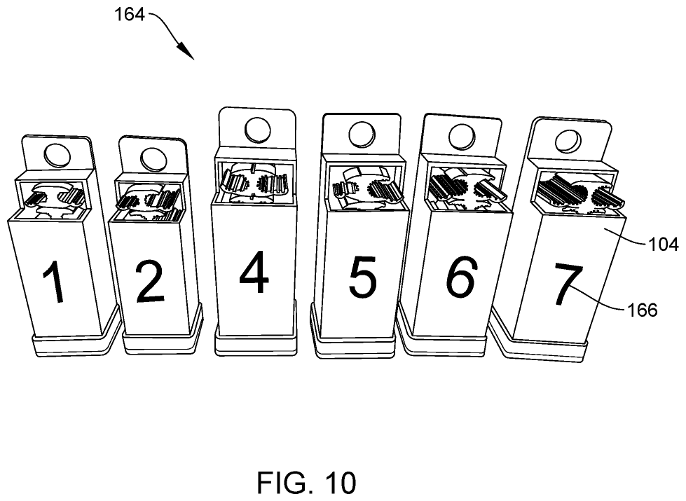

Now referring to FIG. 10, the electrical wire compression connector dispensing container 100 comes in different sizes designed to house different sizes of compression connectors 118 to meet requirements of different operators to squeeze together different gauges of electrical wires. In a preferred embodiment, as illustrated in FIGS. 8-13, a row 164 of different size compression connector containers 100 are connected to a frame of a man-lift basket 174, wherein an indicium 166 is printed, embossed, or detachably placed on the front wall 104 of the housing 102 of each electrical wire compression connector dispensing container 100 for indicating the size of the compression connectors stored in the container 100. The size is associated with the respective gauge of the electrical wires. It will be apparent to a person skilled in the art that the indicium can represent and correspond to any conventional size notation of compression connectors. The indicium 166 is useful for providing a visual alert to an operator of the size of the compression connector stored in the device.

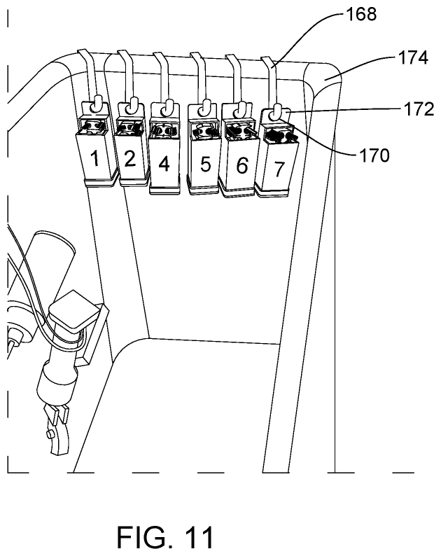

FIG. 11 illustrates different size containers hanging in a work bucket for easy identification and access to compression containers. A conventional hook 168 can be used for passing through the opening 170 of the hanging supporting portion 172 in order to allow the container 100 to hang safely on a work bucket 174, for easy access to the user. When the electrical wire compression connector dispensing container 100 is hanged, the indicium 166 is visible to the user or operator, enabling access to the top compression connector 118 of the plurality of compression connectors 128 of the user's desired size.

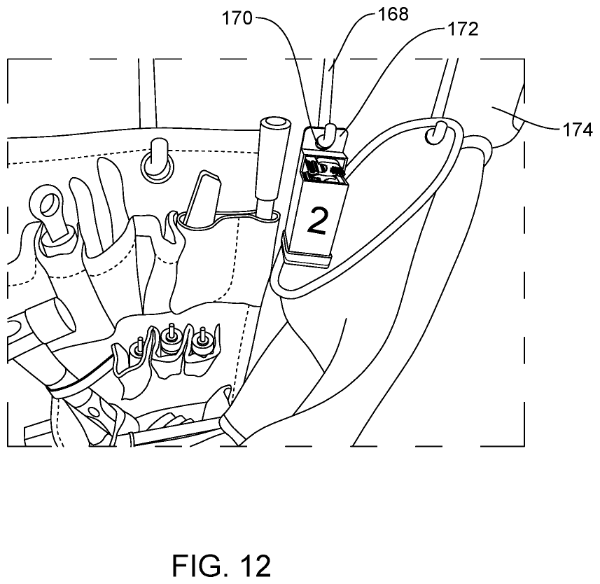

Now referring to FIG. 12, a close up view is illustrated of the electrical wire compression connector dispensing container 100 hanging in the work bucket 174. The hook 168 can be any conventional hook, and the hole 170 is dimensioned to fit hooks 168 used with work buckets 174 by electrical workers. As can be appreciated from the disclosure herein, some of the many advantages of the electrical wire compression connector dispensing container 100 is that the container 100 is lightweight, compact, and can carry a plurality of compression connectors 164 for easy access to compression connectors 128.

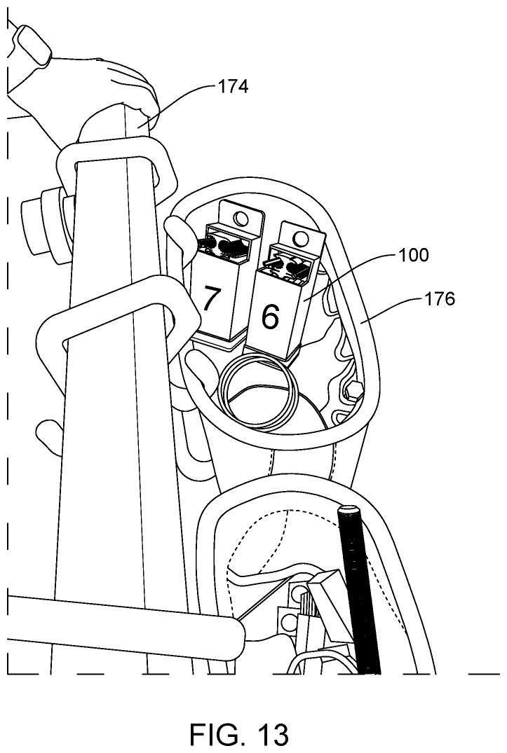

Referring to FIG. 13, the container 100 can be easily placed inside a basket 176 used by electrical operators (or users) for storing a plurality of electrical wire compression connector dispensing containers 100 that contain compression connectors 128. Such basket 176 can be hung on any appropriate and convenient place on or within the work bucket 174.

It should be noted that the electrical wire compression connector dispensing container 100 can be made in different sizes for housing and dispensing different types of electrical connectors. Further, the dispensing container 100 can be made of any weather resistant, durable and sturdy material such as aluminum, any metal, plastic or rubber. Preferably, the housing 102 of the electrical wire compression connector dispensing container 100 is constructed of aluminum, and the spring biased platform is constructed of high density polyethylene (HDPE).

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation within the spirit and scope of the appended claims.

The claimed invention is:

1. An electrical wire compression connector dispensing container comprising:
a housing having a front wall, a bottom surface, a pair of side walls, a rear wall, and a top surface, said housing defining a connector dispenser opening disposed between said top surface and a top edge of said front wall, said connector dispenser opening adapted to individually dispense compression connectors, wherein the spring biased vertically movable horizontal platform is adapted to support a stack of the compression connectors on a top surface thereof;
said connector dispenser opening comprising a first offset side wall portion and a second offset side wall portion;
a torsional spring anchored at a bottom end to an inner surface of said bottom surface and connected at an opposite end to a spring biased vertically movable horizontal platform; and
said platform adapted to move vertically upwards within said housing as a connector is dispensed from the connector dispenser opening, wherein said torsional spring extends vertically upwardly when one of the compression connectors is dispensed from the connector dispenser opening.

2. The electrical wire compression connector dispensing container of claim 1, further comprising an indicium positioned on said front wall for indicating a size of compression connectors stored within said container.

3. The electrical wire compression connector dispensing container of claim 1, further comprising one or more clamps integrated or detachably attached to the rear wall of the housing, wherein the clamps are adapted to removably connect the dispensing container to a frame of a man-lift basket or work bucket.

4. The electrical wire compression connector dispensing container of claim 1, wherein a length of a vertical edge of the first offset side wall portion and a length of a vertical edge of the second offset side wall portion are at least equal to a height of a compression connector.

5. The electrical wire compression connector dispensing container of claim 1, wherein the bottom surface is detachably attached to the base of the housing or alternatively integrated to the base of the housing using welding or a conventional molding technique.

6. The electrical wire compression connector dispensing container of claim 1, wherein the spring biased vertically movable horizontal platform comprises a pair of side edges extending above the top surface of the spring biased vertically movable horizontal platform.

7. The electrical wire compression connector dispensing container of claim 1, further comprising a supporting member extending vertically from said top surface, said supporting member defining an opening adapted to receive a hook for storage of said electrical wire compression connector dispensing container.
